(19) United States
(12) Patent Application Publication
(10) Pub. No.: US 2025/0363135 A1
(43) Pub. Date: Nov. 27, 2025

(54) LOCAL CONTEXT FOR CONTEXT-BASED TABULAR CLASSIFICATION

(71) Applicant: THE TORONTO-DOMINION BANK, TORONTO (CA)

(72) Inventors: Valentin Patrick Marie Thomas, TORONTO (CA); Junwei Ma, TORONTO (CA); Anthony Lawrence Caterini, TORONTO (CA); Rasa Hosseinzadeh, TORONTO (CA); Keyvan Golestan Irani, TORONTO (CA); Guangwei Yu, TORONTO (CA); Maksims Volkovs, TORONTO (CA)

(21) Appl. No.: 19/209,870

(22) Filed: May 16, 2025

Related U.S. Application Data
(60) Provisional application No. 63/651,210, filed on May 23, 2024.

(51) Int. Cl. G06F 16/28; G06F 16/2457

(52) U.S. Cl. CPC G06F 16/285; G06F 16/24575

(57) ABSTRACT

Context-based tabular data models use a context to evaluate a queried data point. Rather than a randomized or full context of domain data points, a local context of data points is selected that is customized for a particular data query. The system uses a pre-trained model, such as a TabPFN, that is trained on a classification for different types of data sets along with a “context” for applying the model with the nearest neighbors of that data point. The number of neighbors may vary and may be determined based on the distance of data points to the query point. The system also optimizes fine-tuning of tabular data models with neighborhood data so that local context can be used to select training batches of data using a common context. This allows local context fine-tuning without excess training costs of single-item training batches.

### CROSS-REFERENCE TO RELATED APPLICATION

This application claims the benefit of U.S. Provisional Application No. 63/651,210, filed May 23, 2024, the contents of which is hereby incorporated by reference in its entirety.

### BACKGROUND

This disclosure relates generally to computer model classification with context inputs, and particularly to improving tabular data models with a local context for a subject data set.

Tabular data is a pervasive modality for practical problems in data science, spanning across a wide variety of domains including finance, healthcare, and science. The diversity and heterogeneity of tabular data pose great challenges for deep learning approaches, unlike modalities such as text and image, in which neural networks can be designed to specifically exploit inductive biases underlying the data. That is, there may be no pre-existing “structure” underlying the data, and individual data fields may be entirely dependent from one another. While image data may inherently include notions that individual pixels are spatially near or far from one another, and text data is naturally sequenced, tabular data often presents no such inherent relationship between its fields. As such, obtaining a performant neural network on a particular tabular data task often results in expensive iterations of training and hyperparameter tuning.

Computer models for tabular data classification have typically used tree-based models, such as XGBoost, that train model parameters directly on the data to be classified. In more recent developments, a transformer-style model may learn a set of model parameters used in conjunction with a “context” to evaluate a current data point. This type of model may use the context to describe the current data set or as a “memory” for recent data items. When parameters of the model are trained with a variety of data set types, the context may be used to describe data points in a data domain currently being evaluated. One example is TabPFN, which is trained using a prior-fitting procedure that exposes the tabular data model to millions of possible data-generating processes, thus encapsulating the heterogeneity of tabular data in the model parameters. The context provided with a particular data query then provides a way to process a “data set” (the context) that may not have been seen in training by considering that context in view of the possible data-generating processes seen by the model.

While this approach may provide for some pre-training and transfer learning in the context of tabular data, there can be significant problems using this type of model effectively.

First, such contexts are typically relatively small compared to the data set from which the new data point is drawn (e.g., the context may describe 100 data points in a data set of 10,000 or more data points) and selecting optimal points from the data set to serve as the context may be a difficult task. In many cases, these models also use mechanisms, such as attention, that quadratically scale with respect to the number of data points in the context and thus significantly penalize increased context size as an approach for resolving the limited information provided by the context. The limited size of the context can limit the efficacy of this type of model as the context cannot effectively describe the contours of the data set.

### SUMMARY

To improve performance of the tabular data models, the context for a particular data query is optimized to use data samples in the query domain expected to be most relevant to the queried data sample. Particularly, a local context is selected based on a distance of the query data sample to data samples in the query domain. In many cases, this enables improved query results with smaller context sizes and enables tabular data models that use a context to increase performance even without further fine-tuning on a particular data domain (e.g., as zero-shot model inference).

The computer model may have its parameters pre-trained on a variety of different tabular data sets. Each data sample, or “instance,” may be represented by a plurality of features that may be disjoint from one another. When forming a prediction, the computer model receives a context including a plurality of data points along with a data point for which to make a classification. By using a context, the computer model may effectively classify new data points for additional domains that, in some embodiments, include domains different from the data used to train the model parameters.

When a query is received with a query data sample, the query domain of data samples is identified and the query data sample is evaluated to determine a distance to the data samples in the query domain. Data samples in the domain are selected as a local context for the query data sample based on the distance to the respective data samples. The local context may include, for example, k nearest neighbors (kNN) of the query data sample. The number of data samples selected for the local context may be fixed or may vary according to, for example, the distance of the query data sample to the domain data samples. The local context is then used for the query when input to the tabular data model to obtain a predicted classification of the queried data sample. This local query allows different query data points to use different local contexts, and enabling the tabular data model to benefit from a context of most-relevant data samples customized to a particular queried data point.

In some embodiments, the tabular data model may also be trained (e.g., fine-tuned) with data from the query domain to improve performance of the tabular data model on data samples of the domain. Training the tabular data model with a local context for each data point may significantly increase the training cost of the tabular data model, as each training batch may then have a unique local context for training. To incorporate aspects of a local context without unduly increasing training cost, a training batch may be used that includes a set of query points and a context that is “near” the query points for the training batch, without being the closest local context for each query point. To generate the training batch, a neighborhood of training data points is determined around a particular training data point (i.e., based on distance to the training data point), such that the neighborhood describes a set of training data samples within “a region” of the training data space. The data points in the neighborhood may then be assigned as a part of the context or a query data point for a training batch for the model. As such, the training batch may include a context in common for the query data points, where the context and query data points are “near” one another (relative to randomly-selected points in the training data set). As such, the model can be trained with a training batch that both considers more “local” data samples and a plurality of query data points.

With these approaches, tabular data models (and particularly in-context tabular data models) may use improved local contexts that customize a context to a queried data point locale and, when applicable, improve fine-tuning with training batches based on a neighborhood of training data samples.

### BRIEF DESCRIPTION OF THE DRAWINGS

FIG. 1 shows a tabular modeling system that includes a tabular data model, according to one embodiment.

FIG. 2 shows an example of a tabular data model, according to one embodiment.

FIG. 3 is a flowchart of a method for evaluating queries for a tabular data model, according to one embodiment.

FIGS. 4A-4B show example plots illustrating tabular model predictions for concentric circle patterns of two classes.

FIG. 4C is a graph of local context performance as the data domain complexity increases.

FIGS. 5A-B illustrate the selection of a training batch of training data based on neighborhood data selection, according to one embodiment.

FIG. 6 illustrates an example flowchart for training a tabular data model with a neighborhood of data points.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

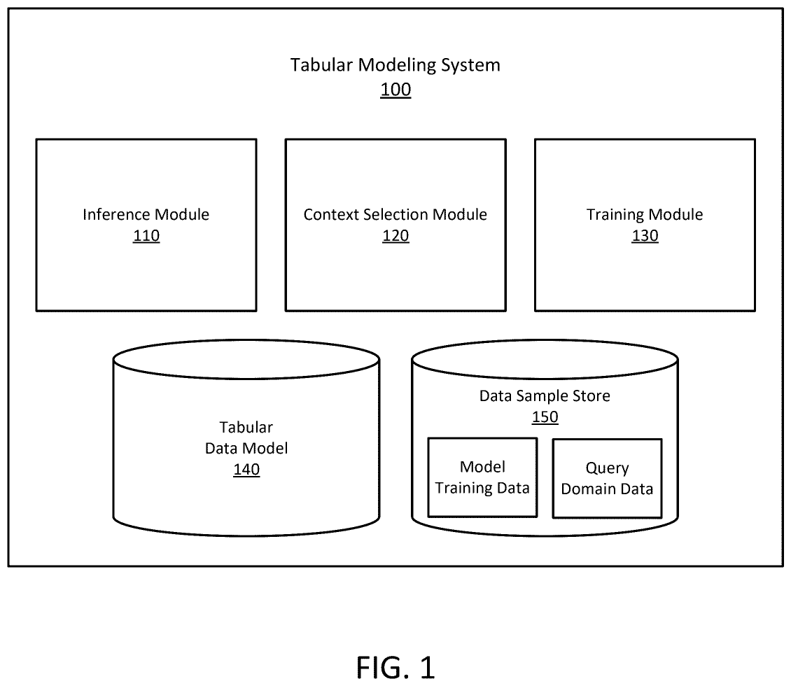

FIG. 1 shows a tabular modeling system 100 that includes a tabular data model 140, according to one embodiment. The tabular modeling system 100 includes various modules and data stores for training and using the tabular data model 140. In practice, additional or different modules and data stores may also be included in the tabular modeling system 100. In addition, the tabular modeling system 100 is shown here without connections to other systems; in practice, the tabular modeling system 100 may be connected to other systems and devices through a suitable network, such as the Internet, for receiving training data and applying the tabular data model 140 to new data items in inference.

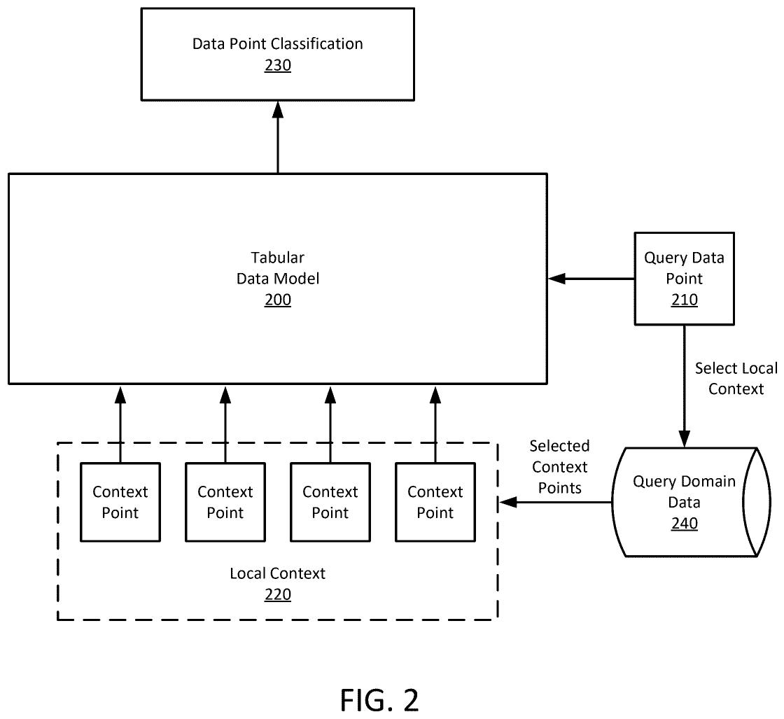

The tabular data model 140 is a trained computer model that learns parameters for interpreting tabular data and predicting data sample classification for an input data sample. The tabular data model 140 receives an input data sample along with a “context” that includes a plurality of context data points as further discussed below and particularly in FIG. 2.

For a tabular data sample (which may also be referred to as a “data point”), the information of a particular data sample may include a plurality of features that may be independent from one another, and may represent, for example, patient data for a hospital or financial data for an individual. That is, the independence of different tabular data features/characteristics (relative to one another) may differentiate this type of data from other types of data, such as image, sound, or video, where the data may be expected to contain higher degrees of correlation across portions of the input. For example, in contrast to tabular data, in image data, individual adjacent pixel data is often similar in value, and positioning may be analyzed to determine something meaningful about the image (e.g., edge detection based on nearby pixel differences). As such, in images and many other modalities, there may be underlying structural relationships between portions of the data that may not exist across tabular data fields.

In the examples herein, the tabular data model generates a classification as an output. The classification may describe, for example, membership in a particular group or a decision to be applied to a data point. In additional examples, the output of the tabular data model 140 be a non-classification task, such that different and/or additional types of data are generated by the tabular data model based on the input data point and the context.

Rather than use a general-purpose context for a data point, the tabular modeling system 100 determines a “local” context for use with a particular data point. The local context enables more effective evaluation of data points by selecting contextual data points expected to be most relevant to evaluating the input data point. As discussed below, this enables better use of the context and, in many cases, enables a smaller context (using a local context) to outperform larger contexts with all domain data points. The tabular modeling system 100 may use data points from a data sample store 150 for a context in training the model or when performing a query. The data sample store 150 may include a set of query domain data representing the set of data points for particular domains that may be used to query the tabular data model 140. For example, queries may be performed for tabular data relating to medical data, such that individual data points in the query domain data represent different individual patients and/or outcomes. When a request is received for evaluating a new data point in that domain, the query domain data may be retrieved to obtain a local context for applying the new data point to the tabular data model 140. As discussed further below, in various embodiments, the tabular data model 140 may be pre-trained, such that the context is used to represent the specific data set relevant to the query (i.e., the query domain) without training or fine-tuning of the tabular data model 140 to the individual domains. The particular way that the relevant data set (the query domain data) is represented in the context may thus significantly impact whether the tabular data model 140 effectively evaluates data points.

FIG. 2 shows an example of a tabular data model 200, according to one embodiment. A tabular data model 200 receives a data point 210 (e.g., features describing a data point) along with a context 220 and processes the data point 210 and the context 220 according to parameters of the trained tabular data model 200 to generate a data point classification 230. The tabular data model 200 may include a number of computer model processing layers (such as fully-connected layers, perceptrons, attention layers, activation layers, and so forth) with configurable parameters for processing the data point 210 and context 220 to yield the data point classification 230. As discussed below, the tabular data model 200 includes parameters trained with a variety of data set types as model training data. As such, the trained parameters of the model have been trained on various data sets with a variety of data set distributions and types of tabular data and may include synthetic data sets representing different types of relationships that may appear in tabular data. Thus, in some embodiments, the tabular data model 200 is trained on a variety of different types of data distributions that may be expected to appear in tabular data, such that the tabular data model 200 may effectively use the input context points to represent various data domains.

To apply the tabular data model 200 with a particular data set, the context 220 provides information about other points (i.e., the context points) within the particular data distribution in which the data point 210 appears. The trained tabular data model 200 may apply one or more attention layers to the context points and/or data point, and in some embodiments may be a transformer-style computer model. In some embodiments, the trained tabular data model is a TabPFN (Tabular Prior-Data Fitted Network) architecture. In some embodiments, the parameters of the trained tabular data model 200 are pre-trained from the perspective of the tabular modeling system 100. As such, the trained tabular data model 200 may encode various types of prior distributions and related processing in the parameters of the trained tabular data model 200, such that the context 220 may be used to describe the particular distribution for evaluating the current data point 210.

In general, however, the number of context points are relatively few and may be 100, 500, or 1000 context points, and may be smaller than the total number of data points available for the data set related to the context. In various types of tabular data models, the architecture (e.g., a transformer architecture and attention mechanisms) may scale model complexity and/or runtime quadratically. As such, modifying the length of the context (e.g., to account for additional context points) may significantly increase processing time or other costs of the tabular data model 200. As discussed further below, the context for a particular data set may be trained to enable refined evaluation of the data point classification for that data set without requiring retraining (e.g., fine-tuning) of the trained tabular data model 200.

To improve application of the tabular data model 200 to a particular query domain data 240, rather than use the same context for many (or all) data points, the query data point 210 being evaluated is used to select a local context 220 of context points from the data points of query domain data 240. For example, the query domain data may have a number of data points significantly larger than a context size, such that a subset of the query domain data 240 is selected as the local context 220. A local context 220 may include, for example, 100 data points selected from 1,000, 10,000, or more data points in the query domain data 240.

Returning to FIG. 1, in operation, the tabular data model 140 processes a data point and a context to generate a data point classification. To perform inference on a new data item, an inference module 110 receives a new data point and identifies the data set (i.e., the query domain data) associated with the new data point. The associated query domain data is used to identify the local context for the data point by a context selection module 120 as further discussed below. The local context, optimized for that particular data point and query domain, may then be provided as an input to the model along with the data point to determine a classification output for that data point, as shown in FIG. 2. The inference module 110 may thus receive data points from various sources (such as external devices), identify the local context relevant to the respective data points with context selection module 120, and classify the data points with the tabular data model 140 based on the respective contexts.

As this process enables using different effective local contexts for different data points within and across data sets, in some embodiments, the same tabular data model 140 can be applied to different data sets (e.g., different data distributions) by selecting an effective local context, enabling re-use of the same tabular data model 140 and avoiding otherwise expensive memory operations of loading separate tabular data models 140 for different data sets. As the number of parameters in the tabular data model 140 may be very large (e.g., in the hundreds of thousands, millions, or billions), this may significantly improve the performance of the tabular modeling system 100, particularly when different data sets are used in practice. As such, the tabular data model 140 in some embodiments may be pre-trained (e.g., on synthetic data for a variety of data distributions) and may be used as-is by the tabular modeling system 100 with a local context as discussed.

The context selection module 120 may determine the local context for a data point in various ways in different embodiments. In general, the context selection module 120 selects data points from the relevant data set (e.g., the query domain data) that are expected to be most relevant to correctly evaluating a subject data point. These data points may be selected as the points that are “closest” to the query data point. In one embodiment, the selected data points are the k nearest neighbors (kNN) of the query data point. Distance between data points (e.g., the query data point and a data point in the query domain) may be measured with any suitable metric.

As one example, the distance between data points may be measured in the domain of the tabular data. For example, tabular data may include various fields having values within various ranges, such as 0-1, 0-100, or another range, which may differ across different fields. As such, the values may be pre-processed or otherwise modified before being used to measure a distance metric between data points. In one embodiment, the values for each field may be normalized to reflect the value of that field relative to a range of values for that field across the relevant domain, for example, to normalize the values to a range between zero and 1. In some embodiments, the normalization may scale values according to the range for the related field, and in other embodiments, the normalization may indicate the respective percentile value of the data point in the field. As such, distances may be measured according to values of the data fields in the tabular data. Distances may be measured, for example, as a Euclidian distance between data points according to differences between respective data fields for the tabular data points.

In additional embodiments, embeddings or other low-level data representations may be used to represent the tabular data points for distance measurements. For example, data points in a domain may be used to train an encoder to an embedding representation of the tabular data points. The encoder may be trained with unsupervised data (e.g., with a reproduction loss when processed by a decoder) to obtain parameters for encoding relevant information about the data point domain. In some embodiments, the embeddings of a data point are used to determine a distance metric between data points, for example, by measuring the distance as a cosine similarity between the embeddings of two data points.

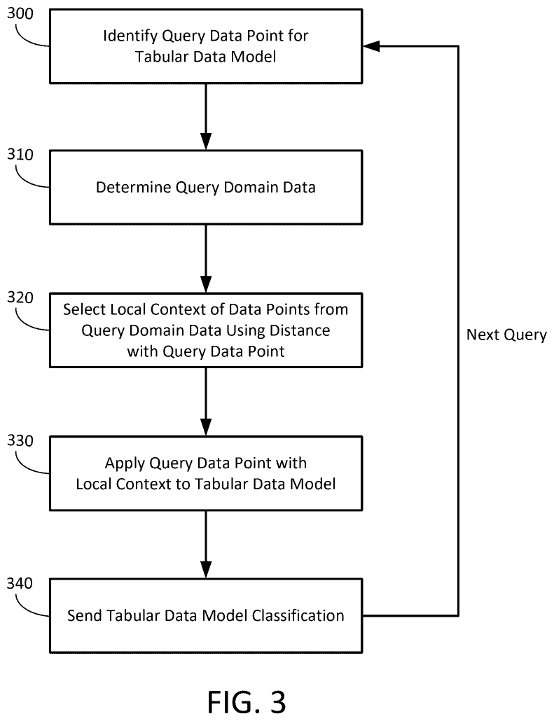

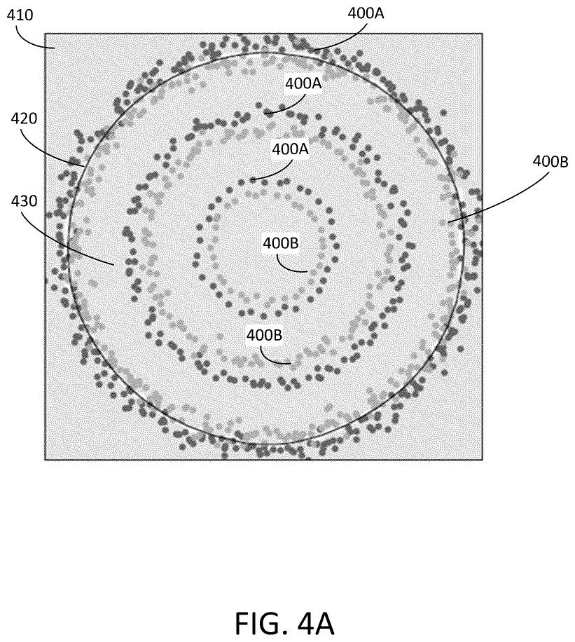

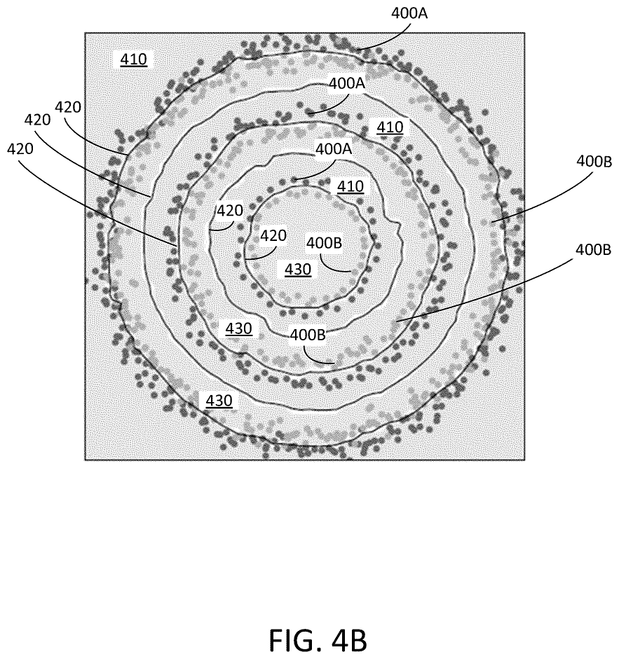

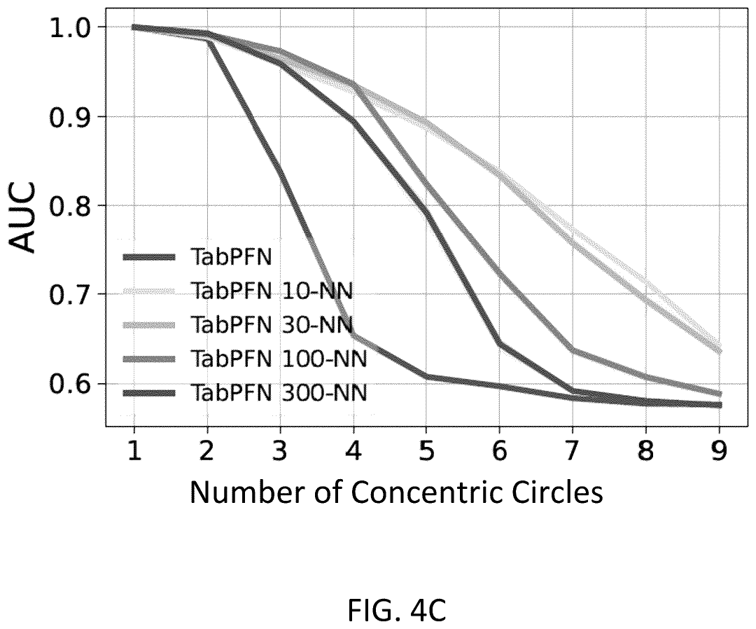

The content selection module 120 may select “local” data points for a query request (e.g., for executing a query received by the inference module 110) or may select a “neighborhood” of data points when used for training (i.e., typically by fine-tuning) by the training module 130. The context selection module 120 may select a number of data points based on the distance to the subject data point (e.g., a query data point or a sampled training data point) according to the distance metric and return the data points to the requesting module (e.g., the inference module 110 or training module 130). The number of selected points may vary in different embodiments and in different circumstances and are discussed further below. The context selection module 120 typically selects a set of nearest neighbors to the subject data point according to the distance metric, although other selection means may also be used in further embodiments. The selected data points and use of local context for queries is further discussed below with respect to FIGS. 3A-4.

In some circumstances, the tabular modeling system 100 includes a training module 130 that may train (e.g., fine-tune) parameters and other configuration settings of the tabular data model 140 for a particular data domain, and may do so for a particular data domain. Other embodiments may include improvements to model training that benefits from local context. The data sample store 150 may include training data related to various data points, which may be referred to as “data points” or “instances,” to be used for determining parameters of the model. The data sample store 150 may include model training data for training model parameters of the tabular data model 140.

In some embodiments, the tabular data model 140 may be trained on various data sets suitable for transfer learning (with an appropriate context) to a variety of other data sets using the context. In these embodiments, the model training data may include data for a variety of domains, simulated data reflecting different types of relationships between tabular data fields, and so forth. The tabular data model 140 may thus learn parameters configured for general relevant relationships among data instances for the various training data sets.

The model training data may be used to train parameters of the tabular data model 140. In some embodiments, the tabular data model 140 is trained by another system and is received by the tabular modeling system 100 as pre-trained. The model training data may include a number of different types of tabular data with different types of relationships between data points, features, and classifications. As such, the model training data may include various distributions with different types of data set contexts. The tabular data model 140 may be trained for various types of data distributions based on the variety of data distributions in the model training data.

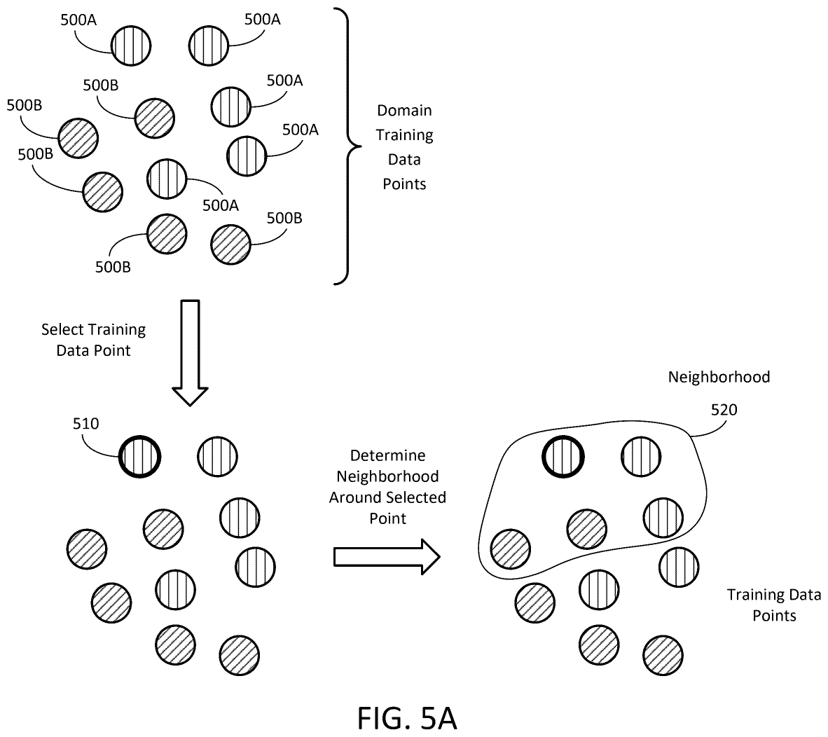

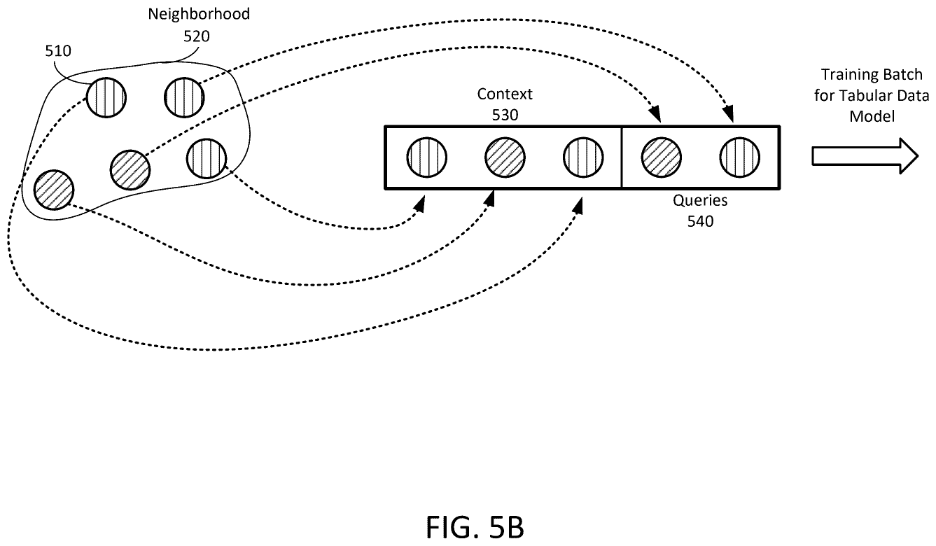

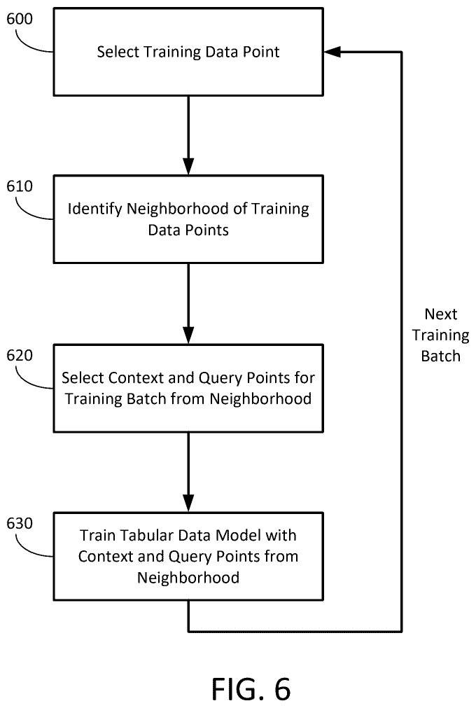

In some embodiments, the training module 130 may train (or further train; i.e., fine-tune) the tabular data model 140 to more directly account for data queries using a local context. That is, rather than training data using random points of training data or “all” training data for a training batch, the training module 130 may use a training process that trains the model with consideration of a local context. Typically, a local context for a query (as discussed herein) may use a number of data points near the queried data point. In some embodiments, a similar local context may be used for training batches by the training module 130 in training the tabular data model 140. However, this may constrain each training batch to a single query data point (and its local context). To more effectively train the tabular data model 140 with a notion of local context, the training module 130 may determine a number of data points in a “neighborhood” and construct a training batch of data based on the data points in the neighborhood, enabling multiple training data points (as “queries”) to share the same context. While the shared context for these points may not match the “local context” that would be used for a query, this “semi-local” context that is shared for query points in a training batch enables locality to be incorporated into the training process without dramatically increasing training cost or the number of training batches. Additional detail discussing the model training process is discussed with respect to FIGS. 5-6.

The tabular modeling system 100 is shown in relation to the components particularly related to the improved operation and training of the tabular data model 140 as discussed herein. As such, the particular environment in which the tabular modeling system 100 operates may differ in various embodiments, as the tabular modeling system 100 may be operated on a server that receives requests from remote computing systems for application of requests to the tabular data model 140. In other embodiments, the tabular data model 140 may be trained by one computing system and deployed to another computing system for application (e.g., downloaded by a mobile device for operation of the tabular data model 140). In additional embodiments, the training of the tabular data model 140 may also be separated to different computing systems training of the model parameters with the model training data may be performed by one system, and training of a context for a data set using the context training data may be performed by another system. As such, the tabular modeling system 100 is any suitable computing system; components as disclosed below may be separated or combined appropriately across different computing systems for operation. For example, training of the tabular data model 140 may also be executed by a plurality of systems in parallel that may share information about modifying model parameters during training. Similarly, further components and features of systems that may include the tabular modeling system 100 itself and systems that may include components of the tabular modeling system 100 may vary and include more or fewer components than those explicitly discussed herein.

FIG. 3 is a flowchart of a method for evaluating queries for a tabular data model, according to one embodiment. This method may be performed, for example, by components of a tabular modeling system 100 as shown in FIG. 1, such as an inference module 110 in conjunction with a context selection module 120. Initially, a query may be identified 300 for application of a tabular data model to a data point associated with the query. For example, a query may be received from an external system to obtain an output (e.g., a classification) of the tabular data model. Initially, to determine a local context for the data query, the query domain data is determined 310 to identify the set of data points associated with a domain of the query. For example, a query request including a query data point for tabular data of a medical data set may include identifying the relevant medical data set as the query domain data for the query.

Next, a local context for the query is selected 320 from the data points of the query domain data. The data points associated with the query domain data may also be referred to as “domain data points.” The query data point is evaluated against domain data points to determine the distance between the query data point and various domain data points as discussed above. A number of the domain data points are selected as a local context for the query data point. After determining the distance between the query data point and the domain data points, the domain data points may be prioritized according to the distance for selection as the local context. In some embodiments, a number of nearest neighbor (NN) domain data points are selected for the local context from the query domain data. The number of data points selected for the local context may be fixed (e.g., 10, 30, or 50 data points) or the number may vary (i.e., be dynamically selected). The number of context points may vary based on the domain, the distance of domain data points to the query data point, types of selected context points, and so forth.

In one embodiment, the number of selected domain data points for the local context may be increased or decreased when the distance of the domain data points is relatively higher or lower. For example, when the distance between the query data point and an initial number of its nearest neighbors is relatively low or below a threshold (i.e., the nearest neighbors are relatively “close” to the query data point), a smaller number of domain data points are selected. Conversely, when the nearest domain data points have a relatively higher distance to the query data point (e.g., above a threshold), a larger number of domain data points are selected.

In additional/further embodiments, the number of selected data points may be based on a number of selected data points of each relevant classification. For example, in some embodiments, the size of the local context may be increased until a minimum number of domain data points are included within each classification. For example, with a minimum number of five data points, an initial number of context data points may include sixteen data points of a first classification and four data points of a second classification. Additional domain data points (i.e., based on distance to the query data point) may then be selected until the local context includes the minimum number of each classification.

The local context is then applied 330 to the tabular data model using the local context. As discussed above with respect to FIG. 2, the local context provides an improved way for the tabular data model to account for the particular domain data and the data points in that domain that are within a region of the query data point. Finally, the tabular data model generates an output (in this case a classification) and the tabular data model classification is sent 340 as a result for the data query. The process may be repeated as new queries are received for processing, such that the related query data point is identified 300, relevant query domain data determined 310, and local context selected 320 for subsequent query requests.

FIGS. 4A-4B show example plots illustrating tabular model predictions for concentric circle patterns of two classes. FIG. 4A shows an example application of a pre-trained tabular data model (particularly, TabPFN) when applied to data points using a “full context” of data points. In this example, each data point is evaluated by the tabular data model using a context that includes all points within the query domain. The data points in this example query domain are classified as a first class 400A (i.e., positively classified) and a second class 400B (i.e., negatively classified) and arranged in a set of alternating concentric circles, as shown in FIG. 4A. The data space is evaluated by the model using a “full context” to determine regions of the data space that would be classified by the tabular data model as positive or negative. Although the full context (here, 1,000 data points) is provided to the tabular data model (i.e., it has access to all data points of the query domain as an input context) in determining a classification, the evaluation of the tabular data model results in a single decision boundary 420 that separates a positively-classified region 410 and a negatively-classified region 430.

FIG. 4B shows an example application of the same pre-trained tabular data model when applied to data points using a local context as discussed herein. In particular, the local context of FIG. 4B selects the k nearest neighbors (kNN) of the evaluated point in the data domain, shown here with k=100. Although the example of FIG. 4A had the full context of 1000 data points, the smaller, local context (k=100) as shown in FIG. 4B effectively learns multiple, correct decision boundaries 420 between the concentric circles of data points of a first class 400A and data points of a second class 400B. The decision boundaries 420 as shown in FIG. 4B result in multiple positively-classified regions 410 and multiple negatively-classified regions 430, more correctly learning the concentric ring pattern than the tabular data model using a full context.

FIG. 4C is a graph of local context performance as the data domain complexity increases. In FIG. 4C, the AUC of local contexts is compared as the number of concentric circles in a simulated data set similar to FIGS. 4A-B is modified. In particular, the context is modified to illustrate the performance of a pre-trained TabPFN model using a full context (“TabPFN”) relative to local context using various context sizes (i.e., a different number of nearest neighbors). Particularly, the local context is shown for local contexts ranging from k=10 (10-NN) to k =300 (300-NN) in the number of nearest neighbors selected for a local context. In all examples, a local context of any size outperformed a “full” context for data point classification. Although in this example, a smaller local context typically outperforms, this was not always the case, as in some instances a local context of k=30 performed better than a smaller local context of k=10 and a larger local context of k=100. As such, in some embodiments, the size of a local context (i.e., the number of data points selected for the local context) may vary and may be selected based on empirical evaluation of the queried data set. In these examples, multiple local context sizes may be evaluated and the number of local data points selected for the local context may be determined as the local context size that performed best on the particular data domain.

FIGS. 5A-B illustrate selection of a training batch of training data based on neighborhood data selection, according to one embodiment. Each training batch represents a context and a set of query points used for training parameters of the tabular data model, for example, to fine-tune the tabular data model to a specific domain. The training batch is evaluated by the tabular data model to determine modifications to the parameters of the model. Typically, each training batch may be applied to modify model parameters before a subsequent training batch. As discussed above, the local context when executing queries may use a set of domain data points near a query data point. However, because the local context may be unique to each data point, using the same local context in training may use a large number of training batches that do not share a context. In one or more embodiments, a plurality of query points is selected for a training batch with a common context from a “neighborhood” of data points, such that the same context, although not an identical local context, as may be used in querying the tabular data model, is used for a plurality of query points. This enables a context to be used in training that uses a more local context (compared to context of all or randomly-selected data points in a training domain) to fine-tune a model with a plurality of query data points, such that each training batch may incorporate additional data (using gradients from the plurality of query points in the training batch), and fewer total training batches may be used relative to training with a unique local context for each data point.

A set of domain training data points may include a set of positive examples 500A and negative examples 500B. As shown in FIG. 5A-B, the position of each data point 500A-B indicates a respective distance between the data points in the training data. Initially, a data point 510 may be selected from the set of domain training data points to seed the selection of a neighborhood of data points. In some embodiments, a data point 510 is randomly selected from the domain training data points 500A-B. In additional embodiments, the data point may be selected based on the classification, such that different training batches are seeded from data points selected from different classified data points. The data point 510 is then used to determine a neighborhood of nearby data points to the seed data point. To generate the neighborhood, additional data points are evaluated for distance to the selected data point 510 and a neighborhood 520 of training data points is selected based on distance to the selected point 510. In the example of FIG. 5A, the neighborhood 520 includes the four nearest neighbors of the selected data point 510. In various embodiments, the number of selected data points for the neighborhood may vary, for example, to vary the size of the context of the subsequent training batch.

As shown in FIG. 5B, the data points in the neighborhood 520 are then used to construct a training batch that uses the data points from the neighborhood. Data points from the neighborhood 520 are selected (i.e., assigned) as either a context 530 or a set of queries 540 for the training batch. Although the selected data point 510 was used to seed the neighborhood 520, that data point is not necessarily designated as context 530 or one of the queries 540. Rather, in some embodiments, the assignment is random to the context 530 or as a query 540, such that while the neighborhood 520 ensures that the set of data points in the training batch are from a similar “region” of the inputs for the data domain, the particular data points selected for the queries 540 may or may not have the context data points 530 as the nearest data points to the queries 540. Rather, by selecting a context 530 of data points this way, a common context 530 may be used for a plurality of queries 540 in the training data batch. The training batch may then be applied to the tabular data model to obtain classifications of the respective queries 540 based on the context 530. In one embodiment, during training the tabular data model may evaluate (optionally, in parallel) a classification for each query 540 by attending to the set of context data points 530 while not attending to other query data points. As such, the set of query points 540 may be evaluated with a common context 530 to tune parameters of the tabular model with data points from a common neighborhood.

FIG. 6 illustrates an example flowchart for training a tabular data model with a neighborhood of data points. This process may be performed, for example, by a training module 130 of a tabular modeling system 100 using model training data from a data sample store 150. After selecting the set of training data for the domain, for each training batch, a data point is selected 600 to seed a neighborhood. As noted above, the selected data point may be selected by various means, such as randomly, based on classification, whether the data point has been included in prior training batches, etc.

Next, the training process identifies 610 a neighborhood of training data points based on a distance to the selected training point. The neighborhood may have a specific number of nearest neighbors to the selected data point, semi-randomized number of data points, data points within a specified distance to the seed data point, and so forth. As noted above, the neighborhood may include the selected data point as a member of the neighborhood. Next, the training data points in the neighborhood may be selected 620 (e.g., assigned) as either a context or a query data point for the training batch as shown in FIG. 5B. The training batch using the context and queries obtained from the neighborhood is then used to train 630 the tabular data model. Additional training batches may then be processed by selecting 600 another training data point to seed additional neighborhoods.

Using a local context and/or further training with neighborhood-aware training batches enables these tabular data models to achieve improved runtime (e.g., with lower contexts) and improved results relative to other tabular data models. Additional examples show that this approach to local context and fine-tuning may also enable such in-context tabular data models to be competitive with other tabular data modeling approaches, such as tree-based models, and particularly enables effective use with larger data sets, enabling additional ways to address data set complexity that was previously ineffective. While neighborhood-based training as discussed above provides additional benefits, as discussed above and shown in FIGS. 4A-C, merely using a local context for evaluation of unseen domain data can enable significantly improved tabular data model performance. As such, approaches using pre-trained tabular data models (such as transformer-based models) trained with various generative processes that simulate the diverse interrelations that exist among the features of realistic tabular datasets can be further improved with local contexts and further fine-tuning.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computing system for tabular data models using localized context, comprising
one or more processors configured to execute instructions; and
a non-transitory computer-readable storage medium containing instructions executable by the one or more processors for:
identifying a query to apply a tabular data model to a query data point;
identifying a set of query domain data including a plurality of domain data points associated with a domain of the query;
selecting a local context of context points from the set of query domain data based on a distance of the context points to the query data point; and
applying the local context and query data point to a trained tabular data model to generate a data point classification of the query data point.

2. The computing system of claim 1, wherein the trained tabular data model is trained with data different from the query domain data.

3. The computing system of claim 1, wherein the trained tabular data model is not trained with data points in the query domain data.

4. The computing system of claim 1, wherein the tabular data model is a transformer architecture having an attention layer that attends to the local context.

5. The computing system of claim 1, wherein selecting the local context comprises determining a number of nearest data points in the set of query domain data to the query data point.

6. The computing system of claim 5, wherein the number of nearest data points is dynamically determined based on the distance of the respective data points in the set of query domain data to the query data points.

7. The computing system of claim 1, wherein the distance of a context data point to the query data point is measured in a tabular data space of the query data point.

8. A method for tabular data models using localized content, comprising:
identifying a query to apply a tabular data model to a query data point;
identifying a set of query domain data including a plurality of domain data points associated with a domain of the query;
selecting a local context of context points from the set of query domain data based on a distance of the context points to the query data point; and
applying the local context and query data point to a trained tabular data model to generate a data point classification of the query data point.

9. The method of claim 8, wherein the trained tabular data model is trained with data different from the query domain data.

10. The method of claim 8, wherein the trained tabular data model is not trained with data points in the query domain data.

11. The method of claim 8, wherein the tabular data model is a transformer architecture having an attention layer that attends to the local context.

12. The method of claim 8, wherein selecting the local context comprises determining a number of nearest data points in the set of query domain data to the query data point.

13. The method of claim 12, wherein the number of nearest data points is dynamically determined based on the distance of the respective data points in the set of query domain data to the query data points.

14. The method of claim 8, wherein the distance of a context data point to the query data point is measured in a tabular data space of the query data point.

15. A non-transitory computer-readable medium for tabular data models using localized content, the non-transitory computer-readable medium comprising instructions executable by a processor for:
identifying a query to apply a tabular data model to a query data point;
identifying a set of query domain data including a plurality of domain data points associated with a domain of the query;
selecting a local context of context points from the set of query domain data based on a distance of the context points to the query data point; and
applying the local context and query data point to a trained tabular data model to generate a data point classification of the query data point.

16. The non-transitory computer-readable medium of claim 15, wherein the trained tabular data model is trained with data different from the query domain data.

17. The non-transitory computer-readable medium of claim 15, wherein the trained tabular data model is not trained with data points in the query domain data.

18. The non-transitory computer-readable medium of claim 15, wherein the tabular data model is a transformer architecture having an attention layer that attends to the local context.

19. The non-transitory computer-readable medium of claim 15, wherein selecting the local context comprises determining a number of nearest data points in the set of query domain data to the query data point.

20. The non-transitory computer-readable medium of claim 19, wherein the number of nearest data points is dynamically determined based on the distance of the respective data points in the set of query domain data to the query data points.
